(19) United States
(12) Patent Application Publication
(10) Pub. No.: US 2008/0019254 A1
(43) Pub. Date: Jan. 24, 2008

(54) OPTICAL PICKUP DEVICE

(75) Inventors: Kazushi Mori, Hirakata-City (JP); Katsutoshi Hibino, Kaizu-City (JP); Kenji Nagatomi, Kaidu-City (JP); Naoyuki Takagi, Fuwa-Gun (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 11/780,875

(22) Filed: Jul. 20, 2007

(30) Foreign Application Priority Data
Jul. 20, 2006 (JP) 2006-198290

(51) Int. Cl. G11B 7/00

(52) U.S. Cl. 369/112.05; 369/44.23

(57) ABSTRACT

A laser beam emitted from a light source is divided into a main beam and two sub-beams by a diffraction grating. A filter is arranged between a collimator lens and an objective lens. A filter unit is arranged in a predetermined pattern in the filter. The filter unit gives a maximum transmittance or a maximum reflectance at an incident angle at which the laser beam is incident in a parallel light state. The filter unit is formed in a pattern in which at least the laser beam reflected from a layer except a recording layer of an irradiation target is prevented from entering a sub-beam sensor pattern.

This application claims priority under 35 U.S.C. Section 119 of Japanese Patent Application No. 2006-198290 filed Jul. 20, 2006, entitled “OPTICAL PICKUP DEVICE”.

### BACKGROUND OF THE INVENTION

1. Field of the Invention

The present invention relates to optical pickup devices, and more particularly, to an optical pickup device suitably used to irradiate laser light on a disk in which a plurality of recording layers are laminated.

2. Description of the Related Art

An optical pickup device for focusing a laser beam onto a disk recording surface is arranged in an optical disk drive which records and reproduces information in and from an optical disk such as a CD (Compact Disc) and a DVD (Digital Versatile Disc).

FIG. 17 shows a basic configuration of the optical pickup device. In FIG. 17, the numeral 11 designates a semiconductor laser, the numeral 12 designates a diffraction grating, the numeral 13 designates a beam splitter, the numeral 14 designates a collimator lens, the numeral 15 designates an objective lens, the numeral 16 designates a cylindrical lens, and the numeral 17 designates a photodetector.

The laser beam emitted from the semiconductor laser 11 is divided into a main beam (0-order diffraction light) and two sub-beams (±1-order diffraction light) by the diffraction grating 12, and the light beams are incident on the beam splitter 13. The laser beams transmitted through the beam splitter 13 are converted into substantially parallel light by the collimator lens 14, and the laser beams are focused on the disk recording surface by the objective lens 15.

The light reflected from the disk reversely proceeds the optical path in which the light is incident on the disk, and the light is partially reflected by the beam splitter 13. After astigmatism is introduced by the cylindrical lens 16, the light is focused on a light receiving surface of the photodetector 17. In the configuration shown in FIG. 17, an astigmatism method is adopted as a technique of detecting focus error.

FIG. 18A shows an arrangement of spots of the three beams (main beam and sub-beams) on the disk recording surface. FIG. 18A shows the state where the three beams are focused on the disk on which grooves and lands are arranged.

As shown in FIG. 18A, in the recording and reproducing operation, the main beam is focused on a groove and the two sub-beams are separately focused on lands which sandwich the groove from both sides. The spots of FIG. 18A are arranged to. perform good tracking error detection by a differential push-pull method to be described later.

FIG. 18B shows light intensity distribution of the main beam and two sub-beams on the disk recording surface.

The recording in the disk is performed only by the main beam and the two sub-beams are used to generate a tracking error signal and a focus error signal. Light intensity of the main beam is set much higher than light intensity of the sub-beam. This is because a laser output from the semiconductor laser 11 is efficiently utilized in the recording. A recording speed to the disk can be higher as the laser beam intensity is increased on the recording surface. Therefore, the laser output from the semiconductor laser 11 is divided into the main beam and the sub-beams such that an intensity portion of the main beam used in the recording is much higher than those of the sub-beams.

A light intensity ratio between the main beam and the sub-beam is determined by diffraction efficiency (usually grating depth) of the diffraction grating 12. Usually the main beam intensity is 10 to 18 times the sub-beam intensity. The ratio is directly reflected on an intensity ratio between the main beam and the sub-beam on the light receiving surface of the photodetector 17.

FIG. 19A illustrates a principle of tracking error detection by the differential push-pull method.

Referring to FIG. 19A, the numerals 171, 172, and 173 designate a quadrant sensor arranged on the photodetector 17. The main beam is accepted by the quadrant sensor 171, and the two sub-beams accepted by the quadrant sensors 172 and 173 respectively. FIG. 19A shows focusing spots of the main beam and the sub-beam located on the quadrant sensors 171, 172, and 173. Light intensity distribution is schematically shown in each spot, and hatching is performed such that the color is brought close to black as the light intensity is increased.

As shown in FIG. 19A, the letters A to L designate sensor units of the quadrant sensors 171, 172, and 173 respectively. Assuming that PA to PL are detection outputs of the sensor units A to L, a differential push-pull signal (DPP) is given by the following equation.

DPP={(PA+PB)−(PC+PD)−k1·{(PE+PF+PI+PJ)−(PG+PH+PK+PL)} (1)

At this point, the coefficient k1 corresponds to a sensitivity multiplying factor of a sub-light receiving unit, and the coefficient k1 is set such that the detection output of the main beam is equal to the summation of the detection outputs of the sub-beams.

As shown in FIG. 18A, when the main beam is in the state where the main beam is focused at the center position of the track (groove), the main beam and two sub-beams located on the light receiving surface of the photodetector 17 become the spot states shown in part (a-2.) of FIG. 19A. In this case, the light intensity distribution of each spot becomes symmetry in relation to one parting line of the quadrant sensor. Accordingly, when the computation is performed by the equation (1), the differential push-pull signal (DPP) becomes zero.

When the main beam is displaced in the radial direction (vertical direction in the paper plane) from the state shown in FIG. 18A, the main beam and two sub-beams located on the light receiving surface of the photodetector 17 become the spot states shown in part (a-1) or (a-3) of FIG. 19A. Parts (a-1) and (a-3) of FIG. 19A shows the states in which the main beam generates track shift from the center of the track toward an outer circumference direction and an inner circumference direction of the disk respectively.

In this case, the light intensity distribution of the main beam and two sub-beams located on the light receiving surface become the state in which the light intensity distribution is biased in the horizontal direction of the paper plane. As can be seen from comparison of parts (a-1) and (a-3) of FIG. 19A, the bias direction of the light intensity distribution in each spot becomes opposite according to the track shift direction of the main beam. The main beam differs from the sub-beam in that the direction in which the light intensity is biased is opposite.

When the computation is performed by the equation (1), the differential push-pull signal (DPP) becomes a negative value in the state shown in part (a-1) of FIG. 19A, and becomes a positive value in the state shown in part (a-3). Accordingly, the track shift of the main beam on the disk can be detected based on the differential push-pull signal (DPP).

In a so-called one-beam push-pull method, a push-pull signal is generated only from the main beam, and the track shift of the main beam is detected based on the push-pull signal. However, in the one-beam push-pull method, a DC offset is generated in the push-pull signal due to inclination of the disk and an optical axis shift of the objective lens, which results in degradation of accuracy of track shift detection. On the other hard, in the differential push-pull method, the DC offset is cancelled by the computation of the equation (1), so that the accuracy of track shift detection can be enhanced.

FIG. 19B illustrates a principle of focus error detection by the differential astigmatism method. In this case, the focusing spots of the main beam and two sub-beams located on the light receiving surface of the photodetector 17 are changed from a perfect circle to an ellipse according to a focus shift.

When the main beam is focused on the disk recording surface, the spot shapes of the main beam and two sub-beams located on the light receiving surface of the photodetector 17 become substantially a perfect circle as shown in part (b-2) of FIG. 19B. On the other hand, when the focal position of the main beam is shifted forward and backward with respect to the disk recording surface, the spot shapes of the main beam and two sub-beams located on the light receiving surface of the photodetector 17 are deformed as shown in part (b-1) or (b-3) of FIG. 19B.

In this case, a differential astigmatism signal (DAS) is obtained by the following equation.

DAS={(PA+PC)−(PB+PD)}−k2·(PE+PG+PI+PK)−(PF+PH+PJ+PL) (2)

where k2 is a coefficient which has the same meaning as k1.

In the on-focus state shown in part (b-2) of FIG. 19B, because the main beam and two sub-beams located on the light receiving surface of the photodetector 17 have the spot shape of substantially perfect circle, when the computation of the equation (2) is performed, the differential astigmatism signal (DAS) becomes zero. On the contrary, when the focal position of the main beam is shifted forward and backward from the recording surface, the spot shape of each beam is deformed into an ellipse in a different direction depending on the focus shift direction as shown in parts (b-1) and (b-3) of FIG. 19B. Therefore, when the computation of the equation (2) is performed, the differential astigmatism signal (DAS) becomes sometimes negative ((b-1) of FIG. 19B), and sometimes positive ((b-3) of FIG. 19B). Accordingly, the focus shift of the main beam on the disk recording surface can be detected based on the differential astigmatism signal (DAS).

As with the track shift detection, in the focus shift detection, the focus error signal can be generated only from the main beam. However, when the focus error signal is generated only from the main beam, the push-pull signal is superposed as a noise on the focus error signal in traversing the track of the spot on the disk, which results in a problem that a good focus error signal cannot be obtained. On the contrary, in the differential astigmatism method, because the push-pull signal which is a noise is cancelled by the computation of the equation (2), the good focus error signal can be obtained.

Thus, in order to enhance the accuracy of tracking error signal and focus error signal, the detection signal based on the sub-beam plays a significant role.

A disk (hereinafter referred to as “multi-layer disk”) in which a plurality of recording layers are laminated has been developed and commercialized in response to a demand of recording large-capacity information in the disk. In the next-generation DVD which is currently being commercialized, the recording layers can be laminated corresponding to a blue laser beam having a wavelength of about 400 nm.

The differential push-pull method and the differential astigmatism method can be adopted even in this kind of multi-layer disks. However, when these techniques are used on the multi-layer disk, the light (stray light) reflected from the recording layer except the recording layer of the recording and reproducing target is incident on the photodetector 17, which results in a problem of lowering the accuracy of focus error signal and tracking error signal. This is so-called a problem of signal degradation caused by the stray light.

FIGS. 20A and 20B show a stray light generation state where a laser beam is focused on a multi-layer disk having two recording layers. In FIGS. 20A and 20B, the signal light (light reflected from the recording layer which is of the recording and reproducing target) is shown with a solid line, and the stray light is shown with a broken line.

FIG. 20A shows a state in which the laser beam emitted from the optical pickup device is focused on a recording layer L1. In this case, the light which is transmitted through the recording layer L1 and reflected from a recording layer L0 becomes the stray light. Because the light reflected from the recording layer L0 becomes divergent light whose starting point is located farther than the recording layer L1 with respect to the objective lens 15, the light becomes a slightly focused state compared with the parallel light, after transmitted through the objective lens 15. Accordingly, because the focal point by the collimator lens 14 is brought close to the disk side of the light receiving surface of the photodetector 17, the focal point becomes a widely spread spot on the light receiving surface of the photodetector 17.

FIG. 20B shows a state in which the laser beam emitted from the optical pickup device is focused on the recording layer L0. In this case, the light reflected from the recording layer L1 becomes the stray light. Because the light reflected from the recording layer L1 becomes divergent light whose starting point is located closer to the objective lens 15 compared with the recording layer L0, the light becomes a slightly divergent state compared with the parallel light, after transmitted through the objective lens 15. Accordingly, because the focal point by the collimator lens 14 is separated from the disk with respect to the light receiving surface of the photodetector 17, the focal point becomes a widely spread spot on the light receiving surface of the photodetector 17.

FIG. 21 shows an irradiation state of the stray light on the light receiving surface of the photodetector 17. In this case, the light receiving surface is irradiated with the stray light such that all the quadrant sensors 171, 172, and 173 are covered with the stray light. There are three stray light beams including the stray light based on the main beam and the stray light based on the two sub-beams, the stray light of the sub-beam is also incident on the light receiving surface while overlapping the stray light of the main beam. However, the stray light of the sub-beam has light intensity which has little influence on the focus error signal and tracking error signal, so that only the stray light of the main beam is shown in FIG. 21 for convenience sake.

FIG. 22 shows light intensity distribution of the signal light and the stray light on the light receiving surface of the photodetector 17. As shown in FIG. 22, peak intensity of the stray light is much lower than peak intensity of the main beam signal light. Therefore, the stray light has little influence on the main beam signal light. On the contrary, because the light intensity of the stray light located at the sub-beam position is brought fairly close to the intensity of the sub-beam signal light, the influence of stray light on the sub-beam signal light becomes a large problem.

As described above, the sub-beam plays a significant role in enhancing the accuracy of tracking error signal and focus error signal. Therefore, when the light intensity of the stray light is brought close to the intensity of the sub-beam signal light, the sub-beam has a large influence on the tracking error signal and focus error signal, which causes a risk of remarkably deteriorating performance of the optical pickup device as a whole.

Therefore, the following techniques are proposed to solve the problem. FIG. 23A shows a configuration of the optical pickup device according to a first technique. In the configuration example of FIG. 23A, a light shielding member is inserted into an optical path of the laser beam, and the stray light is blocked by a light shielding portion provided on the light shielding member. At this point, FIG. 23B shows the spot states of the main beam and sub-beam and the stray light irradiation state on the light receiving surface of the photodetector.

As shown in FIG. 23B, in the configuration example, the stray light is prevented from entering the quadrant sensor. However, at the same time, because part of the signal light is also blocked by the light shielding portion, a region (shown by “N” in FIG. 23B) where the reflected light is lost is generated in the spots of the main beam and of the sub-beam on the light receiving surface of the photodetector. Particularly, the lost region in the spot of the main beam signal light becomes a problem. That is, the lost region in the spot of the main beam signal light is generated in the central portion of the spot having strong light intensity, which results in a problem of remarkably lowering quality of the RF signal or the focus error signal.

FIG. 24A shows a configuration of the optical pickup device according to a second technique. In the configuration example of FIG. 24A, a prism having two critical angle planes (first critical angle plane and second critical angle plane) is arranged between the collimator lens and the objective lens. At this point, the first critical angle plane and the second critical angle plane reflect only the light having a predetermined incident angle (critical angle) or larger. Therefore, half of the stray light is blocked in the first critical angle plane, and the other half is blocked in the second critical angle plane.

In this case, because the critical angle condition is steep, the stray light is substantially eliminated on the light receiving surface of the photodetector as shown in FIG. 24B. However, at the same time, because the sub-beam signal light is incident on the prism while shifted from the parallel light state, the sub-beam signal light is also blocked when it is incident on the first critical angle plane and the second critical angle plane, and is not introduced onto the light receiving surface of the photodetector as shown in FIG. 24B.

### SUMMARY OF THE INVENTION

An aspect according to the present invention provides an optical pickup device for irradiating a disk with a laser beam, the optical pickup device including a light source which emits the laser beam; a diffraction grating which divides the laser beam into a main beam and two sub-beams; an objective lens which focuses the main beam and the two sub-beams on a recording layer; a collimator lens which is arranged in an optical path between the light source and the objective lens; a filter which is arranged between the collimator lens and the objective lens, and in which a filter unit for giving a maximum transmittance or a maximum reflectance at an incident angle at which the laser beam is incident in a parallel light state is arranged in a predetermined pattern; and a photodetector which has a main beam sensor pattern and a sub-beam sensor pattern, the main beam sensor pattern and the sub-beam sensor pattern receiving the main beam and the two sub-beams reflected from the recording layer respectively, wherein the filter unit is arranged in the filter in a pattern in which at least the laser beam reflected from a layer other than the recording layer which is of an irradiation target is prevented from entering the sub-beam sensor pattern.

In the optical pickup device according to the aspect of the present invention, at least the stray light is prevented from entering the sub-beam sensor pattern. Therefore, the accuracy of various error signals generated based on the output from the sub-beam sensor pattern is enhanced.

### BRIEF DESCRIPTION OF THE DRAWINGS

The above and other objects and features of the present invention will become more apparent from the following description of embodiments taken in conjunction with the accompanying drawings.

FIG. 1 shows a configuration of an optical pickup device according to an embodiment of the present invention;

FIG. 2 schematically shows a transmittance property of a filter unit according to an embodiment of the present invention;

FIGS. 3A and 3B show configuration examples of the filter unit according to the embodiment;

FIGS. 4A, 4B, and 4C show configuration examples of the filter unit according to the embodiment;

FIGS. 5A and 5B show configuration examples of the filter unit according to the embodiment;

FIGS. 6A and 6B show configuration examples of the filter unit according to the embodiment;

FIGS. 7A and 7B show a pattern of the filter unit according to the embodiment and an irradiation state of stray light;

FIG. 8 shows light intensity distribution of the signal light and stray light according to the embodiment;

FIGS. 9A and 9B show a pattern of the filter unit according to the embodiment and an irradiation state of the stray light;

FIGS. 10A and 10B show a pattern of the filter unit according to the embodiment and an irradiation state of the stray light;

FIG. 11 shows a modification of the optical pickup device according to the embodiment;

FIGS. 12A and 12B show a pattern of the filter unit according to the embodiment and an irradiation state of the stray light;

FIGS. 13A and 13B show a pattern of the filter unit according to the embodiment and an irradiation state of the stray light;

FIGS. 14A and 14B illustrate a method of forming the filter unit according to the embodiment;

FIG. 15 shows a modification of the optical pickup device according to the embodiment;

FIGS. 16A and 16B show a pattern of the filter unit according to the embodiment and a reflectance property;

FIG. 17 shows a configuration of an optical pickup device according to the related art;

FIGS. 18A and 18B show an irradiation state of a laser beam on a disk and light intensity distribution;

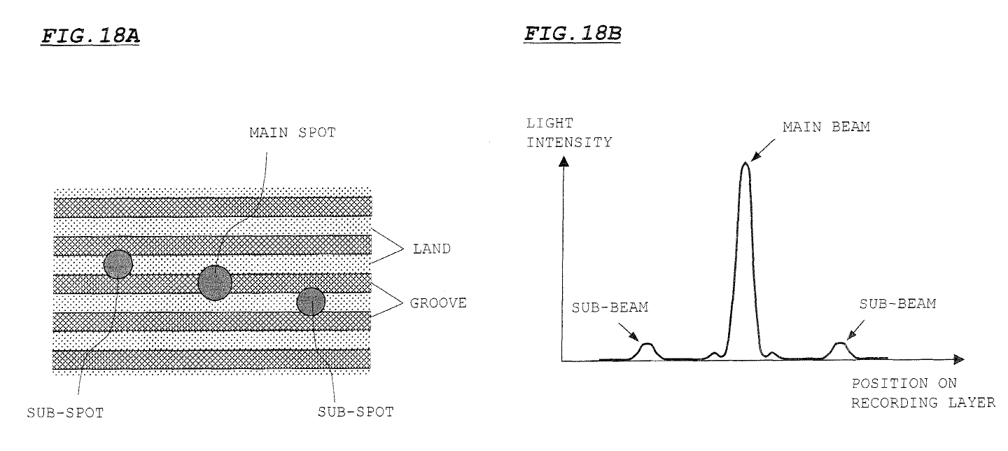

FIGS. 19A and 19B show states of a main beam and sub-beams on a photodetector;

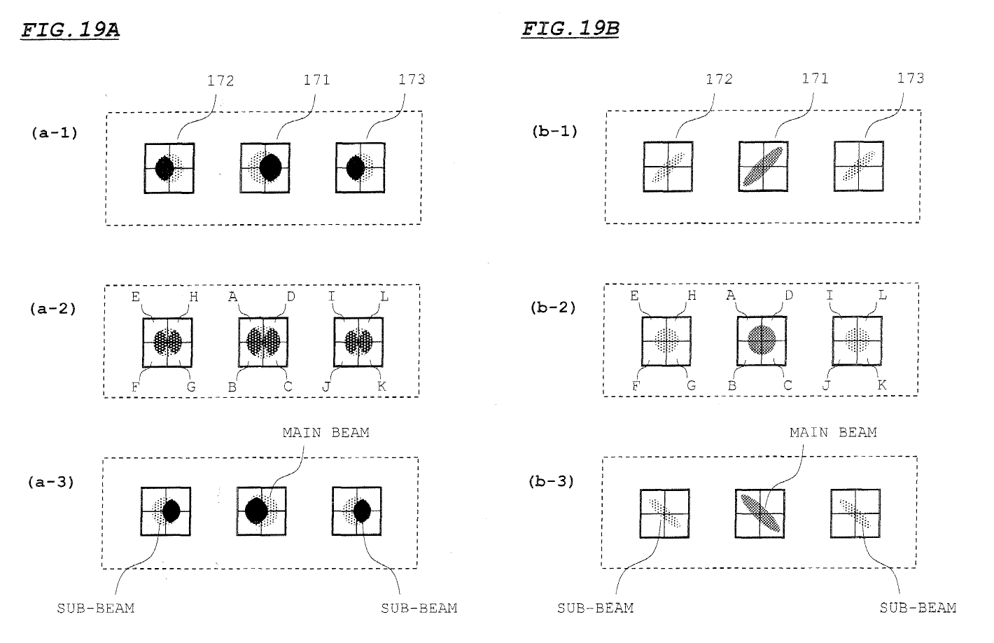

FIGS. 20A and 20B illustrate an optical path of the stray light according to the related art;

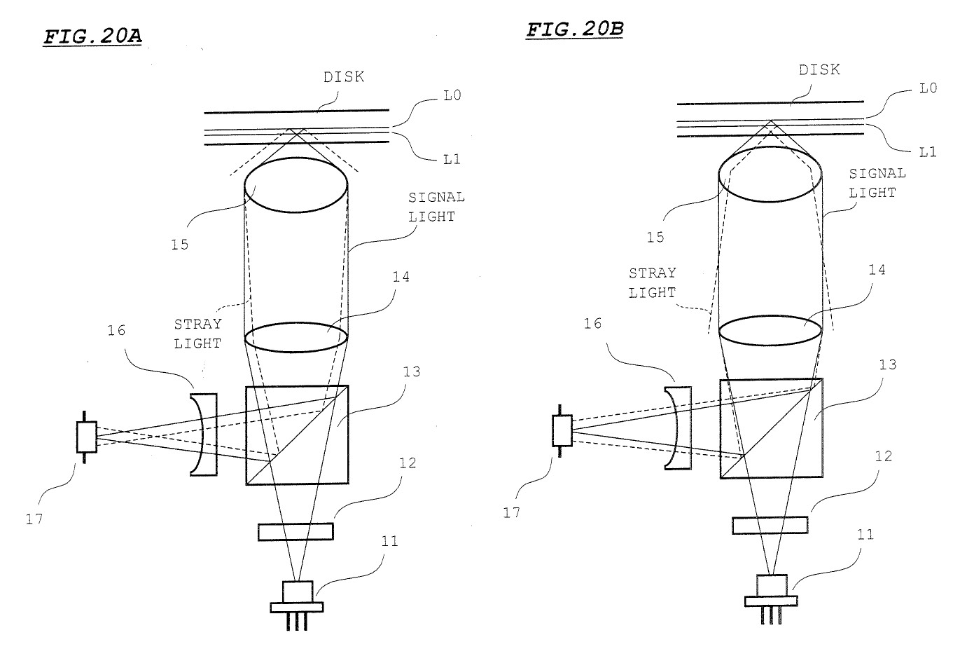

FIG. 21 shows an irradiation state of the stray light according to the related art;

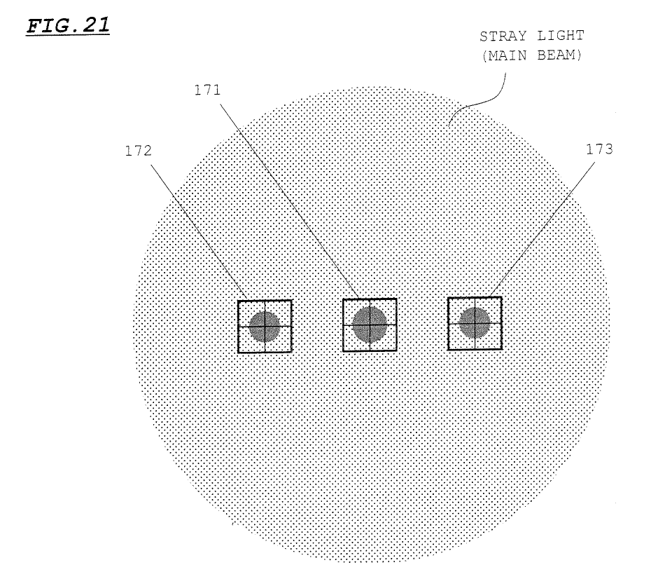

FIG. 22 shows light intensity distribution of the signal light and the stray light according to the related art;

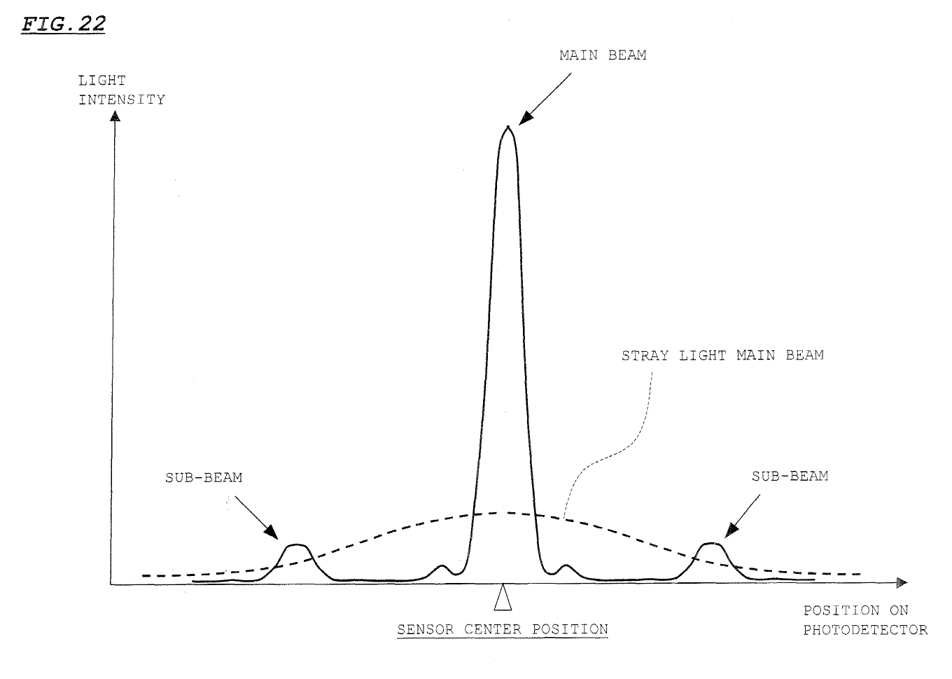

FIGS. 23A and 23B illustrate a technique of suppressing the stray light according to the related art; and

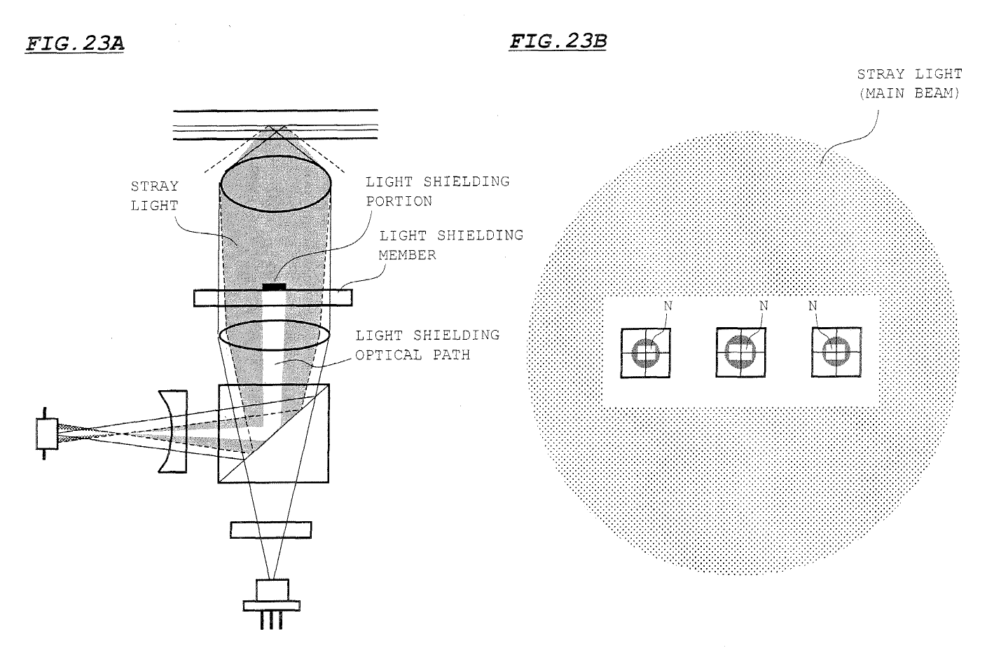

FIGS. 24A and 24B illustrate a technique of suppressing the stray light according to the related art.

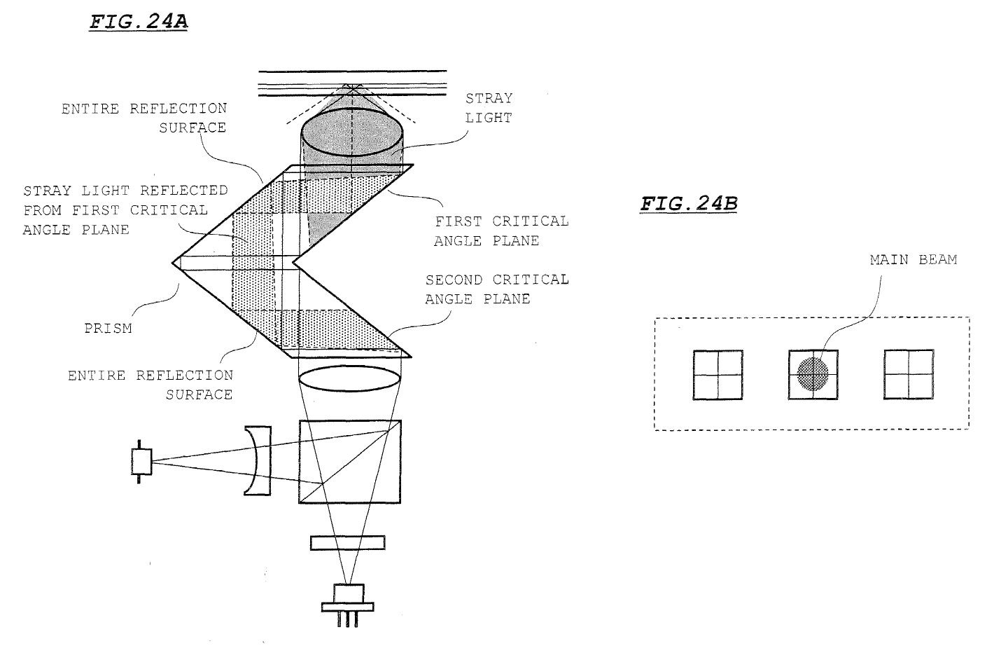

However, the drawings are used for illustration by way of example, and the present invention is not limited thereto.

### DESCRIPTION OF THE PREFERRED EMBODIMENTS

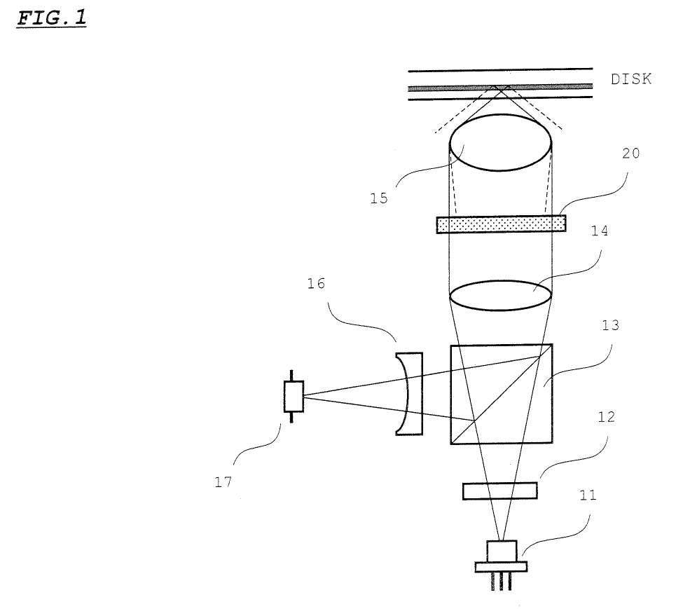

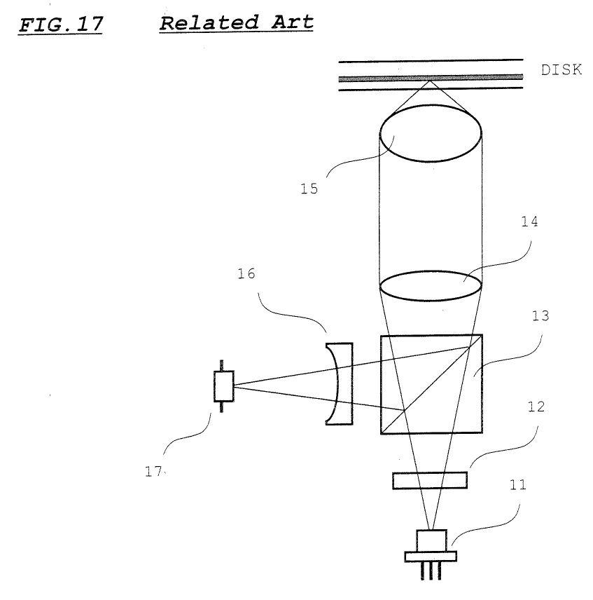

FIG. 1 shows a configuration of an optical pickup device of an embodiment according to the present invention. The same component as in the configuration of FIG. 17 is designated by the same numeral, and the description thereof will be omitted.

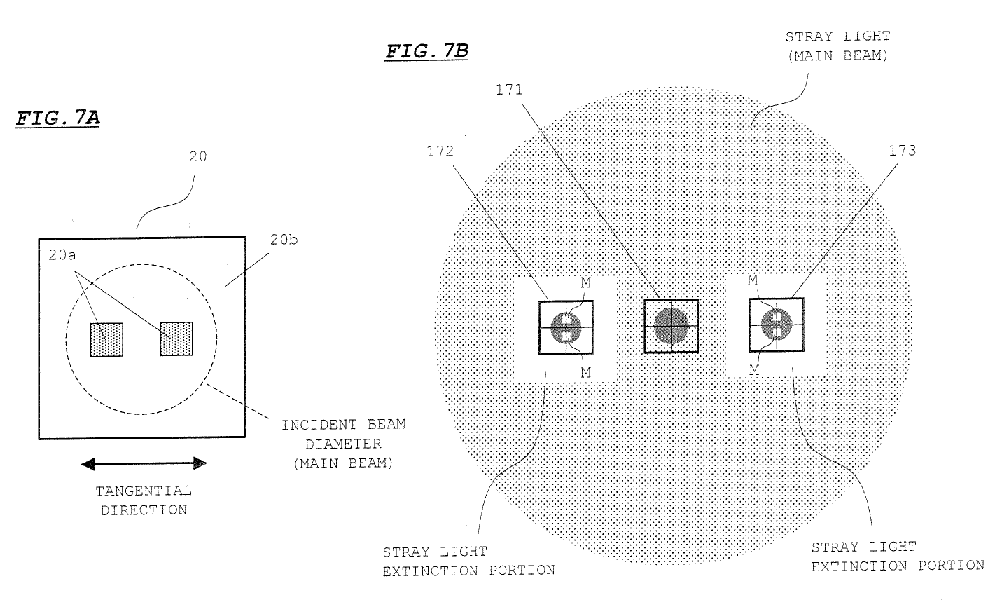

In the present embodiment, a filter 20 is arranged in an optical path between a collimator lens 14 and an objective lens 15. In the filter 20, a filter unit 20a (see FIG. 7A) is partially formed, and the filter unit 20a gives a different transmittance depending on the incident angle. The influence of the stray light on the sub-beam is suppressed by the filter 20. Therefore, the accuracy of various signals such as the tracking error signal is ensured at a practical level.

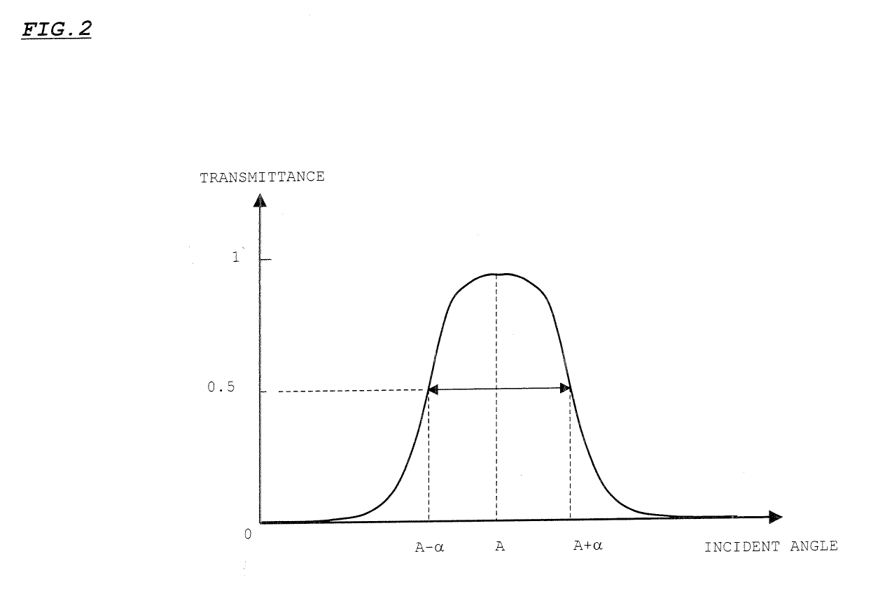

FIG. 2 schematically shows a transmittance property in the filter unit 20a. The filter unit 20a has transmittance distribution which has a width of ±α while centered at an incident angle A. The incident angle A becomes 0° when the light is incident in parallel with an optical axis of the filter unit 20a. As another embodiment, obviously the incident angle A may be 0°.

Then, a configuration of the filter unit 20a will be described.

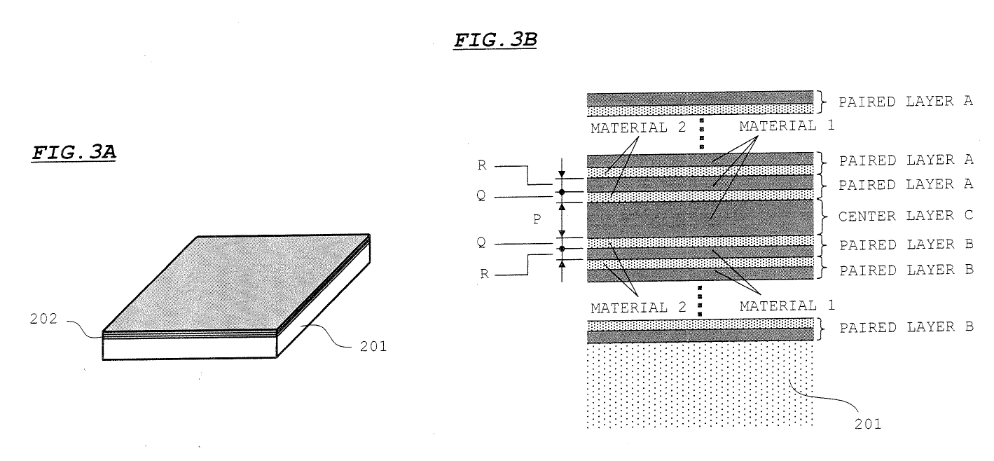

FIGS. 3A and 3B show a case in which the filter unit 20a is configured by forming a multi-layer film 202 on a substrate 201. As shown in FIG. 3B, the multi-layer film 202 is formed by laminating periodic multi-layer films including a plurality of paired layers A and B with a center layer C vertically sandwiched between the periodic multi-layer films. Each of the paired layers A and B is made of two kinds of materials.

For example, the substrate 201 is made of SiO₂, the center layer is made of TiO₂, and materials 1 and 2 constituting the paired layers 1 and 2 are formed by TiO₂ and SiO₂.

In the present configuration example, as the number of paired layers is increased, the width α of the transmittance distribution shown in FIG. 2 is decreased. The incident angle A can be changed by appropriately adjusting parameters. For example, a thickness P of the center layer is set to 0.441 μm, a thickness R of the material 1 of the paired layer is 0.144 μm, a thickness Q of the material 2 is set to 0.07 μm, and the number of pairs is set to eight in both the upper and lower portions. In this case, a transmittance property of A=0° and α=0.39° is obtained for a wavelength of 405 nm.

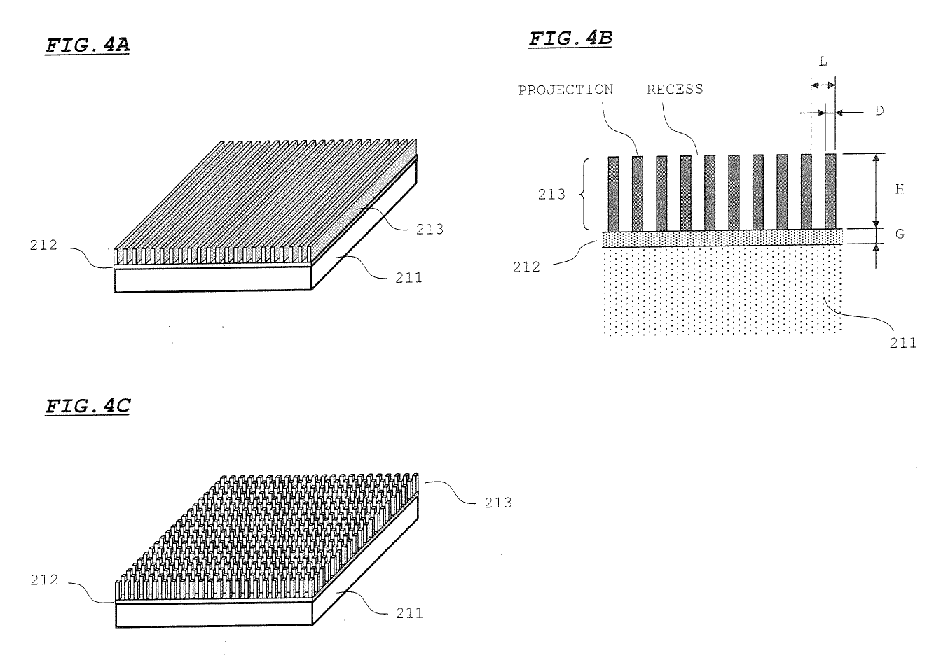

FIGS. 4A, 4B, and 4C show a case in which the filter unit 20a is configured by forming a waveguide layer 212 and a fine grating 213 on a substrate 211. As shown in FIGS. 4A and 4B, the fine grating 213 is formed in such a manner that projections having a constant width D and a height H are arranged at a constant pitch L on the waveguide layer 212 having a thickness G. Similarly to the case of FIGS. 3A and 3B, in the present configuration example, the incident angle A and the width α can be changed by appropriately adjusting the parameters.

For example, the substrate 211 is made of glass, the waveguide layer 212 is made of CORNING #7059 glass (manufactured by CORNING INCORPORATED), the projection of the grating layer 213 is made of TiO₂, and a recess of the grating layer 213 is in air. Assuming the parameters to be G=0.160 μm, L=0.200 μm, D=0.120 μm, and H=0.231 μm, the transmittance property of A=0+ and α=0.23° is obtained for the wavelength of 405 nm. In this case, the transmittance distribution is in a one-dimensional direction (thickness direction of the projection). In order to develop the transmittance distribution in a two-dimensional direction, the two elements of FIG. 4A may be prepared and superposed while grating directions differ from each other by 90°, or another waveguide layer 212 and another grating layer 213 whose grating direction is changed by 90° may be formed on the back side of the substrate 211. As shown in FIG. 4C, the grating layer 213 of FIGS. 4A and 4B may be divided at a constant pitch in the longitudinal direction to form a grating layer having a two-dimensional periodic structure.

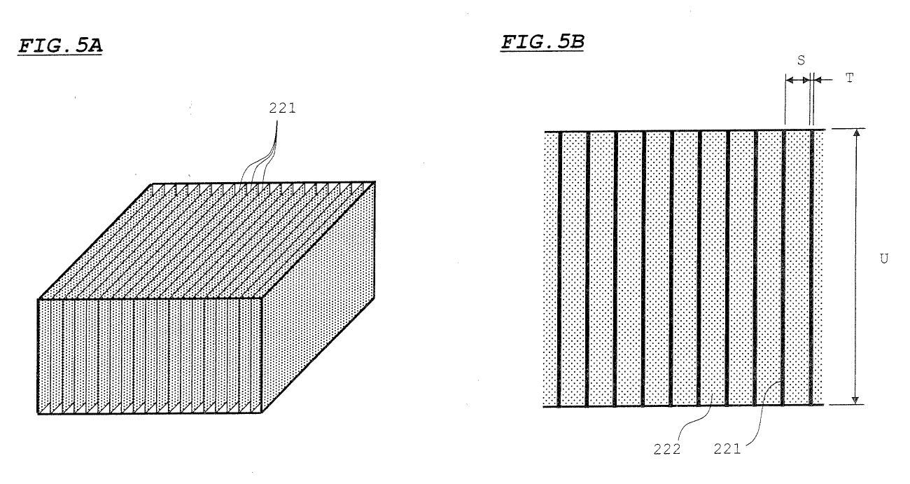

FIGS. 5A and 5B show a case in which the filter unit 20a is configured by a fine blind structure. As shown in FIG. 5B, in the fine blind structure, absorption layers 221 having a thickness T and a width U are arranged at pitch S, and a transmission layer 222 is arranged between the absorption layers 221. Similar to the cases of FIGS. 3A and 3B and FIGS. 4A, 4B, and 4C, in the present configuration example, the incident angle A and the width α can be changed by appropriately adjusting the parameters.

For example, the transmission layer 222 is made of SiO₂ and the absorption layer 221 is made of aluminum. Assuming that S=19.8 μm, T=0.2 μm, and U=940 μm, the transmittance property of A=0° and α=0.31° is obtained for the wavelength of 405 nm. Such a structure can be obtained as follows. For example, transparent sheets on which aluminum is evaporated are laminated and cut in a desired length (U). Although the absorption layer 221 is made of aluminum as a design example, the present invention is not limited thereto. Any material which absorbs the wavelength of the light source used in the optical pickup device may be used as the absorption layer 221. For example, an adhesive agent may be used.

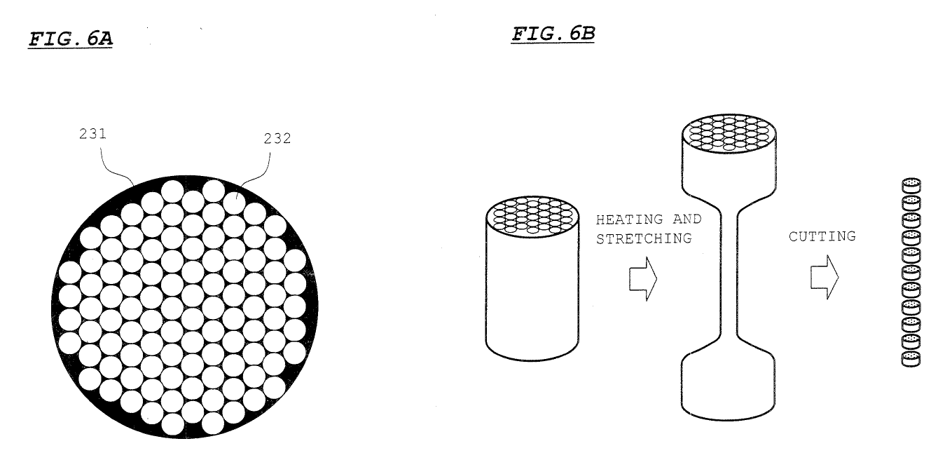

In the configuration example of FIGS. 5A and 5B, the transmittance distribution is given in a one-dimensional direction (pitch direction of the absorption layer 221). In order to give the transmittance distribution in a two-dimensional direction, the two elements of FIGS. 5A and 5B are prepared and superposed while absorption walls differ from each other by 90°, or a two-dimensional fine blind structure in which through-holes 232 having a constant diameter are arranged at a constant pitch in an absorption material 231 is used as shown in the top view of FIG. 6A. As shown in FIG. 6B, a relatively large two-dimensional blind structure is prepared, the structure is heated and stretched, and a part which is reduced in the similar shape is cut to obtain the deep and fine two-dimensional blind structure. A first half of this producing method is well known as a method of producing an optical fiber.

Thus, the configuration examples of the filter unit 20a have been described. However, the configuration of the filter unit 20a is not limited to the above configuration examples, and the filter unit produced by other methods and structures may obviously be used.

### CONFIGURATION EXAMPLE 1

FIG. 7A shows a configuration of the filter 20.

In this configuration example, the filter units 20a are formed in two rectangular regions which are separated from each other in a disk tangential direction with an incident beam optical axis (center of incident beam) at the center. The two rectangular regions have two-fold rotational symmetry relative to the optical axis of the incident laser beam. For example, the transmittance property of the filter unit 20a is set to A=0° and α=0.20°. The numeral 20b designates a transparent portion.

FIG. 7B shows a state in which the laser beam is incident on a light receiving surface of the photodetector 17 when the filter unit of FIG. 7A is used. In FIG. 7B, a boundary of a stray light extinction portion does not indicate a boundary of existence of the light, but indicates a position on which the light whose transmittance is reduced to 0.5 in FIG. 2 is incident. The position of stray light extinction portion is controlled by adjusting the positions where the filter units 20a of FIG. 7A are arranged.

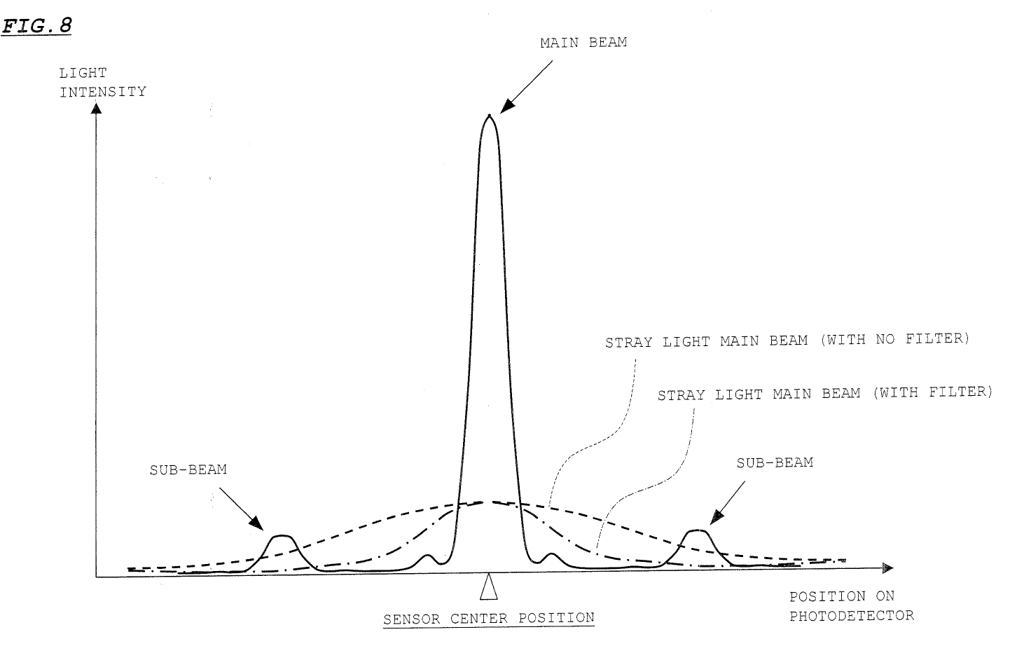

In the stray light beams incident on the filter units 20a, the larger incident angle to the filter unit 20a the stray light beam has, the more the stray light beam is reduced. Accordingly, although the stray light is also incident on the stray light extinction portion of FIG. 7B, because the stray light is reduced to a negligible level at the sub-beam incident position as shown in FIG. 8, the stray light has little influence on the generation of the error signal.

In the signal light (light reflected from the recording layer which is of the recording and reproducing target) of the main beam, because the whole light is incident on the filter unit 20a at the incident angle of 0°, the extinction portion is not generated in the spot of the signal light as shown in FIG. 7B. Therefore, a good RF signal can be obtained.

Because the signal light of the sub-beam incident on the filter unit 20a in the state in which the signal light is slightly shifted from the parallel light, an extinction portion “M” where the signal light is reduced by the filter unit 20a is generated in the spot of the sub-beam. However, as shown in FIG. 7A, the two filter units 20a are arranged in the disk tangential direction, and the extinction portions “M” generated by the filter units 20a are rotated by 90° by the astigmatism action of the cylindrical lens 16. Therefore, as shown in FIG. 7B, the extinction portions “M” are arranged in the direction in which the extinction portions “M” have a little influence on the push-pull signal (the direction in which a difference between signals is not taken). Accordingly, the extinction portions “M” have an extremely little influence on the tracking error signal, and the good tracking error signal can be obtained even when the extinction portions “M” are generated.

Because the two filter units 20a are arranged in the two-fold rotational symmetry relative to the optical axis of the incident laser beam, the two extinction portions “M” generated in the sub-beam spot region are in the two-fold rotational symmetry relative to the laser beam optical axis on the sensor pattern. The two extinction portions “M” have an equal influence on the two signals which are subtracted when the push-pull signal is generated based on the sub-beam spot, so that the influence of the extinction portion on the push-pull signal can be prevented.

Thus, in the present configuration example, the adverse influence of the stray light on the signal light can be prevented without impairing various signals at practical level.

### CONFIGURATION EXAMPLE 2

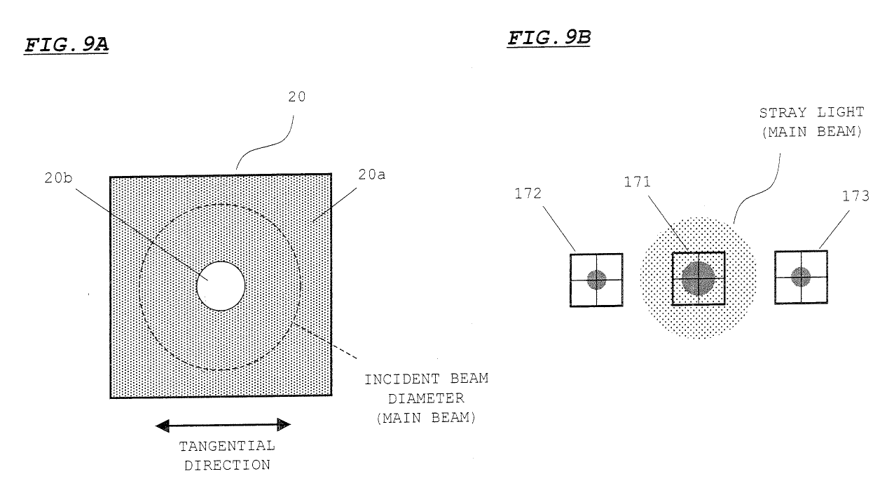

FIG. 9A shows another configuration of the filter 20.

In this configuration example, the filter unit 20a is formed in the region except a circular portion 20b near the incident beam center. For example, the transmittance property of the filter unit 20a is set to A=0° and α=0.20°.

FIG. 9B shows a state in which the laser beam is incident on the light receiving surface of the photodetector 17 when the filter unit of FIG. 9A is used. As shown in FIG. 9B, in the present configuration example, the light is reduced around the whole circumference of the main beam. Accordingly, as in the configuration example 1, the influence of the stray light on the sub-beam signal light can be prevented.

In the present configuration example, because the light is reduced in the peripheral region of the sub-beam signal light by the filter unit 20a, a spot diameter of the sub-beam signal light is slightly smaller than that of the configuration example 1. According to the study performed by the inventors, the spot diameter of the sub-beam signal light corresponds substantially to the diameter of the circular portion 20b.

However, the spot diameter of the sub-beam signal light can be adjusted to a practical level by optimizing the diameter of the circular portion 20b of the filter 20 according to an optical system of the individual optical pickup device.

In the present configuration example, too, because no extinction portion is generated in the spot of the main beam signal light, a good RF signal can be obtained. Thus, in the present configuration, the adverse influence of the stray light on the signal light can also be prevented without impairing various signals at practical level.

In the above two configuration examples, the inclination angle A is set to 0° in the transmittance property of the filter unit 20a. This is because the filter 20 is arranged at the right angle to the parallel light optical axis. However, when the filter 20 is arranged at the right angle to the parallel light optical axis, there may be a problem that the laser beam reflected from the surface of the filter 20 in the optical path toward the objective lens 15 is incident on the photodetector 17. In order to avoid the problem, preferably the filter 20 is arranged in a manner slightly oblique to the parallel light optical axis. In this case, it is necessary that the inclination angle A in the transmittance property of the filter unit 20a be equalized to the inclination angle of the filter 20.

### CONFIGURATION EXAMPLE 3

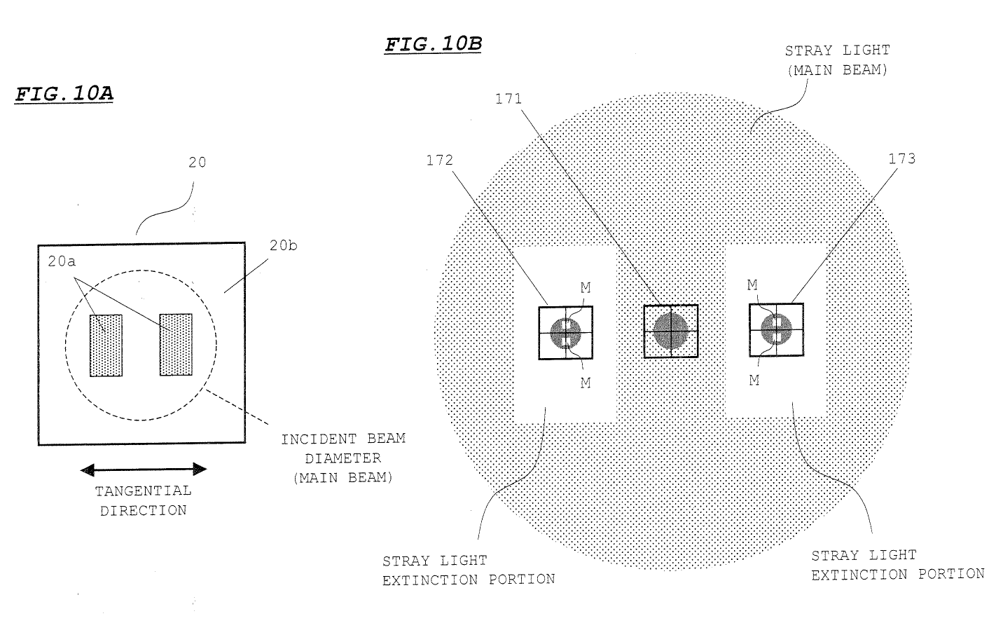

FIG. 10A shows still another configuration of the filter 20.

In this configuration example, the filter unit 20a of the configuration example 1 shown in FIG. 7A is extended in the disk radial direction. In the case of the configuration example 1, when the filter 20 is fixed in the optical path, the stray light extinction portion shown in FIG. 7B is vertically moved according to the movement in the radial direction of the objective lens 15 due to the tracking operation, and a stray light portion having strong light intensity is possibly incident on a spot range of the sub-beam signal light. On the contrary, in the present configuration example, because the filter unit 20a is extended in the disk radial direction, the stray light portion having strong light intensity is never incident on the spot range of the sub-beam signal light, even when the stray light extinction portion is vertically moved according to the displacement of the objective lens 15. Therefore, a good error signal can be generated.

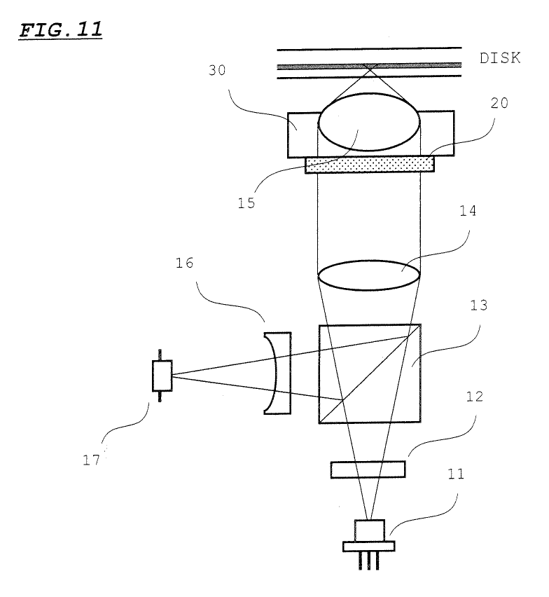

In the present configuration example, the problem caused by the displacement of the objective lens 15 is solved by extending the filter unit 20a in the disk radial direction. Alternatively, as shown in FIG. 11, the filter 20 is fixed to a holder 30 which holds the objective lens 15, and the filter 20 is synchronized with the objective lens 15 to solve the problem.

### CONFIGURATION EXAMPLE 4

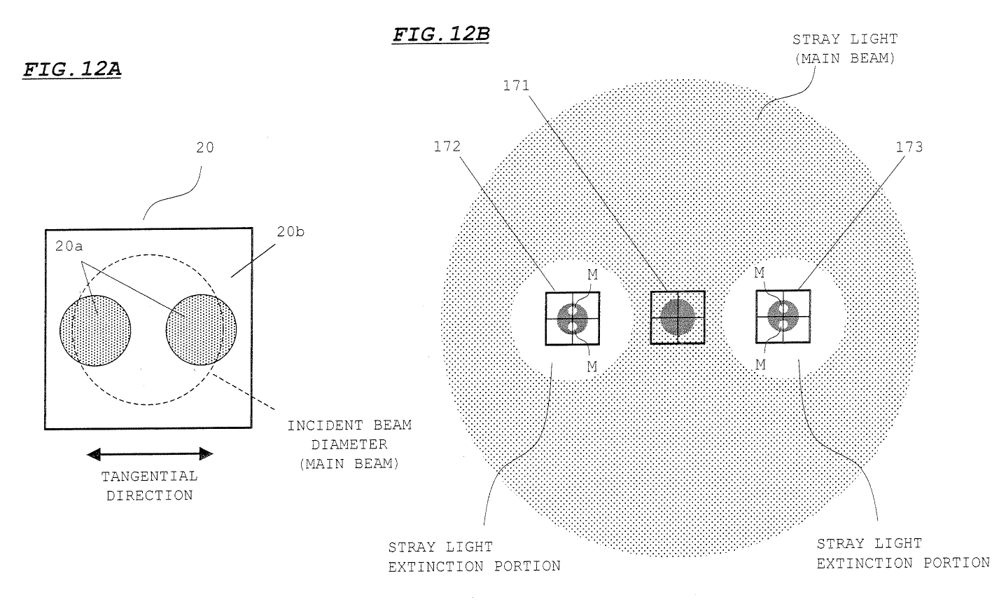

FIG. 12A shows still another configuration of the filter 20.

In this configuration example, the filter unit 20a of the configuration example 1 shown in FIG. 7A is formed into a circular shape. In this case, the stray light extinction portion becomes a circular shape as shown in FIG. 12B. The present configuration example is easily applied to the case in which the filter unit 20a is produced by the method shown in FIG. 6B. The two filter units 20a are arranged in the two-fold rotational symmetry relative to the optical axis of the incident laser beam. The effect of this configuration example is equal to that of the configuration example 1.

In the present configuration example, as in the configuration example 3, the filter unit 20a is extended in the disk radial direction, or the filter 20 is synchronized with the objective lens 15, which allows the problem caused by the displacement of the objective lens 15 to be prevented.

### CONFIGURATION EXAMPLE 5

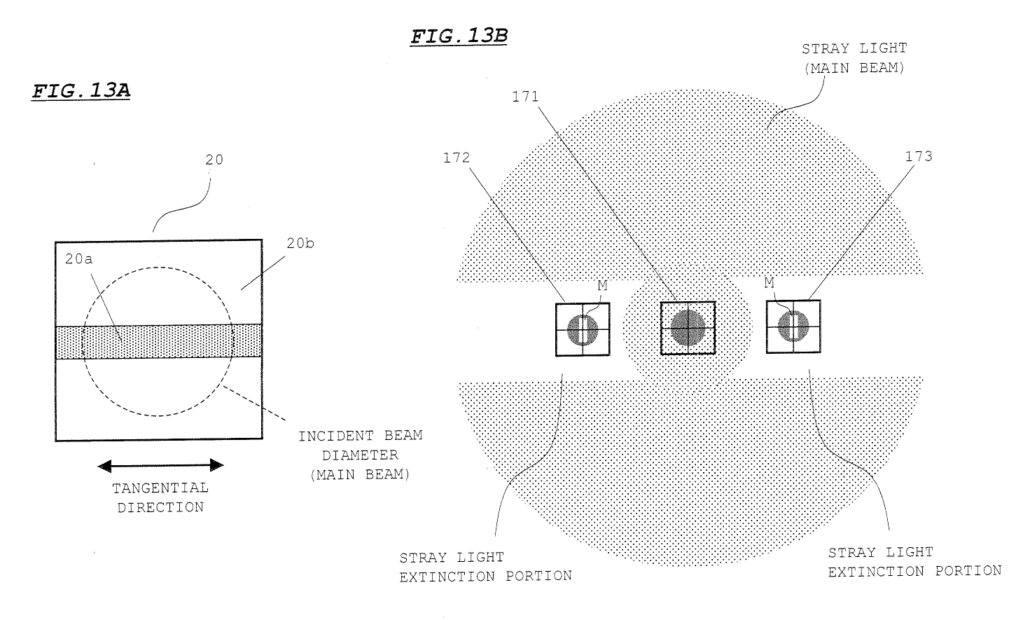

FIG. 13A shows still another configuration of the filter 20.

In this configuration example, the filter unit 20a is formed into a stripe shape in the tangential direction. When the filter 20 of the present configuration example is used, the laser beam incidence onto the light receiving surface of the photodetector 17 becomes the state shown in FIG. 13B. In this case, because the stray light incident on the filter 20 is in the state close to the parallel light in the vicinity of the filter central portion, the light receiving surface of the photodetector 17 is irradiated with the light while the light is not reduced by the filter unit 20a. Therefore, as shown in FIG. 13B, the vicinity of the quadrant sensor 171 is irradiated with the stray light. Similarly to the case shown in FIGS. 7A and 7B, the extinction portion “M” is generated in the spot of the sub-beam signal light, and the extinction portion “M” of the present configuration example is one in which the two extinction portions “M” of FIG. 7B are connected to each other.

The effect of the present configuration example is equal to that of the configuration example 1. In the present configuration example, because the filter unit 20a is formed into a stripe shape, the filter 20 is easily formed. For example, in the present configuration example, a plurality of filter units 20a are produced on a large-area substrate, and the substrate is cut into a desired size to obtain the filter 20.

In the present configuration example, similarly to the case shown in FIG. 11, the problem caused by the displacement of the objective lens 15 can be prevented by synchronizing the filter 20 with the objective lens 15.

(Filter Unit Forming Method)

A method of forming a pattern of the filter unit 20a in the above configuration examples will be described.

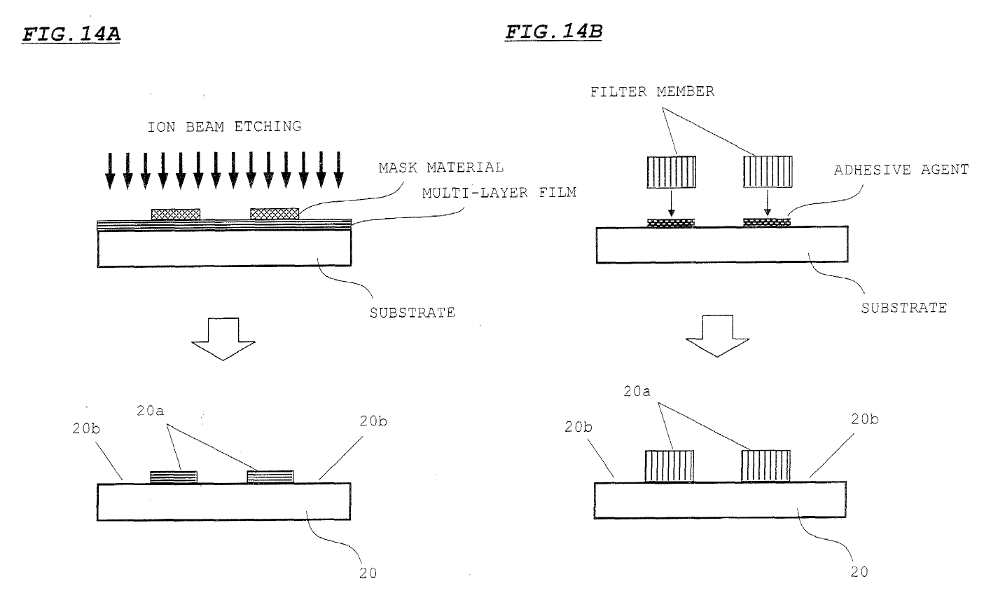

FIG. 14A shows a forming method using a widely known photolithography technique, and the method of FIG. 14A is applied to form the filter unit 20a having the structure shown in FIGS. 3A, 3B, 4A, 4B, and 4C. That is, according to this method, the filter structure is formed all over the substrate surface, a mask material is formed on the filter structure in a desired pattern, and the filter structure exposed to the outside of the mask is removed by, e.g., ion beam etching. Then, the mask material is removed to obtain the filter unit 21a having the desired pattern.

FIG. 14B shows a method of fixing an already-patterned filter member onto the substrate with e.g., an adhesive agent, and the method of FIG. 14B is applied to form the filter unit 20a having the structure shown in FIGS. 5A, 5B, 6A, and 6B.

In the above embodiment, the filter unit is arranged on the substrate. Alternatively, the filter unit may be formed on the surface of another optical component (for example, quarter-wave plate) located in the optical path of the optical pickup device.

(Modification of Optical System)

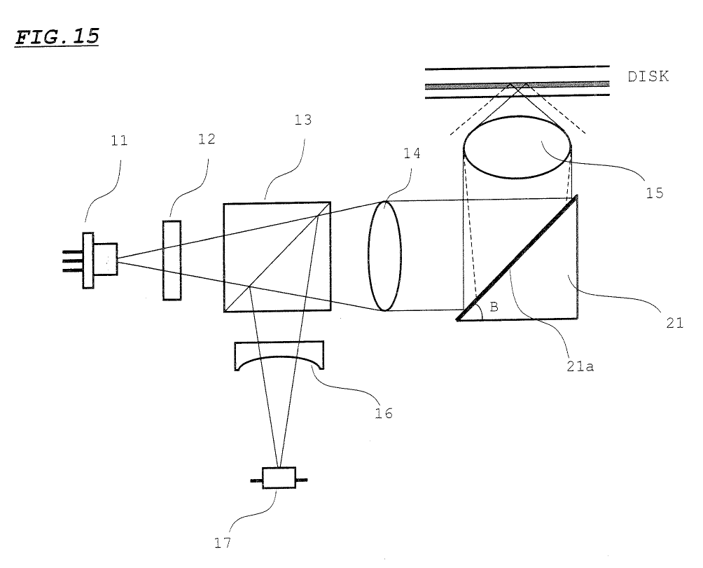

In the above description, the transmission type filter 20 is arranged in the optical path. Alternatively, a reflection type filter can be arranged in the optical path to exert the same stray light removing function. FIG. 15 shows a configuration where the reflection type filter unit is used. The same component as in the configuration of FIG. 17 is designated by the same numeral, and the description thereof will be omitted.

In the configuration example of FIG. 15, a rise mirror 21 is arranged between the collimator lens 14 and the objective lens 15, and the filter unit 21a is formed in a predetermined pattern on the mirror surface.

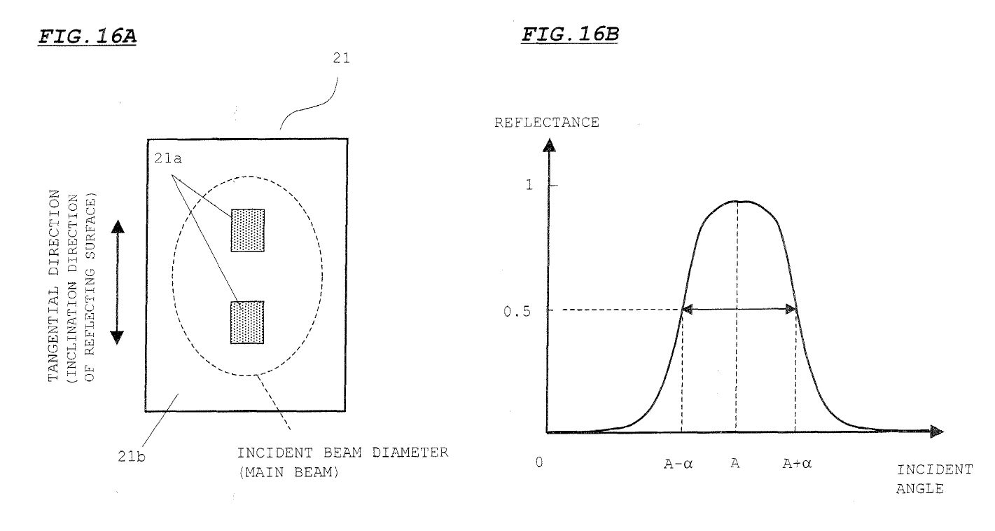

FIG. 16A shows a pattern of the filter unit 21a on the reflecting surface 21b. This means that the effect equivalent to that of the configuration example 1 shown in FIGS. 7A and 7B is obtained. FIG. 16B schematically shows dependence of the reflectance on the incident angle in the filter unit 21a. In the case where an inclination angle B (see FIG. 15) of the mirror surface is set to 45°, the incident angle A is set to 45°. The filter unit 21a of the present configuration example can be formed with a so-called wire grid structure (grating structure made of a conductive material) as well as a multi-layer film structure and a structure in which the waveguide and the fine grating structure are combined.

As described above, according to the present embodiment, the influence of the stray light on the sub-beam signal light can effectively be prevented. Therefore, a good error signal can be generated.

In the present embodiment, as shown in FIG. 2, the transmittance distribution of the filter units 20a and 21a is not steeply formed like a rectangular shape, but is changed relatively gently. Even when the incident angle of the sub-beam (signal light) is slightly shifted from the desired incident angle, the sub-beam (signal light) is not rapidly reduced by the filter units 20a and 21a, so that the reduction of the sub-beam (signal light) on the sensor pattern can effectively be prevented.

In the present embodiment, there is a trade-off relationship between the prevention of the stray light from being incident on the sensor pattern for receiving the sub-beam and the securement of light quantity of the sub-beam (signal light). Accordingly, as shown in FIG. 2, the relatively gentle transmittance distribution of the filter units 20a and 21a can perform the adjustment such that the reduction of the sub-beam (signal light) is decreased as much as possible while incidence of the stray light on the sensor pattern for receiving the sub-beam is permitted to a practical level. Moreover, the relatively gentle transmittance distribution can relatively widen an attachment attitude allowable error of the filter 20 in producing the optical pickup device. Therefore, the position adjustment can be facilitated in attaching the filter 20.

The present invention is not limited to the above described embodiments. It should be understood that various modifications of the present invention can appropriately be made without departing from the scope of the technical idea shown in claims.

What is claimed is:

1. An optical pickup device for irradiating a disk with a laser beam, the optical pickup device comprising:
a light source which emits the laser beam;
a diffraction grating which divides the laser beam into a main beam and two sub-beams;
an objective lens which focuses the main beam and the two sub-beams on a recording layer;
a collimator lens which is arranged in an optical path between the light source and the objective lens;
a filter which is arranged between the collimator lens and the objective lens, and in which a filter unit for giving a maximum transmittance or a maximum reflectance at an incident angle at which the laser beam is incident in a parallel light state is arranged in a predetermined pattern; and
a photodetector which has a main beam sensor pattern and a sub-beam sensor pattern, the main beam sensor pattern and the sub-beam sensor pattern receiving the main beam and the two sub-beams reflected from the recording layer respectively,
wherein the filter unit is arranged in the filter in a pattern in which at least the laser beam reflected from a layer other than the recording layer which is of an irradiation target is prevented from entering the sub-beam sensor pattern.

2. The optical pickup device according to claim 1, wherein the filter units are arranged in two regions, the regions being separated from each other in a tangential direction of the disk with an optical axis of an incident laser beam at the center.

3. The optical pickup device according to claim 2, wherein the two regions are in two-fold rotational symmetry relative to the optical axis of the incident laser beam.

4. The optical pickup device according to claim 2, wherein an optical element is arranged to introduce astigmatism in the optical path between the collimator lens and the photodetector.

5. The optical pickup device according to claim 2, wherein the filter is integrated with the objective lens so as to synchronize with the objective lens.

6. The optical pickup device according to claim 2, wherein the two regions have a rectangular shape, and a width in a radial direction of the disk is larger than a width in the tangential direction in the two rectangular regions.

7. The optical pickup device according to claim 2, wherein the two regions have a circular shape, and a width in a radial direction of the disk is larger than a width in the tangential direction in the two circular regions.

8. The optical pickup device according to claim 1, wherein the filter unit is arranged in a region which extends in the tangential direction of the disk in such a manner as to cross the optical axis of the incident laser beam.

9. The optical pickup device according to claim 1, wherein the filter unit is arranged in a region which is separated from the optical axis of the incident laser beam by a predetermined radius.

10. The optical pickup device according to claim 1, wherein the filter unit is configured by forming a filter structure in an optically transparent member which transmits the laser beam, the filter structure having angle dependence in which the maximum transmittance is given at the incident angle at which the laser beam is incident in the parallel light state.

11. The optical pickup device according to claim 1, wherein the filter unit is configured by forming a filter structure in a mirror which reflects the laser beam, the filter structure having angle dependence in which the maximum reflectance is given at the incident angle at which the laser beam is incident in the parallel light state.
